(19) United States
(12) Patent Application Publication
(10) Pub. No.: US 2017/0339664 A1
(43) Pub. Date: Nov. 23, 2017

(54) FACILITATING EVENT BASED NOTIFICATIONS

(71) Applicant: Ayantra, Inc., Fremont, CA (US)

(72) Inventors: Ashok Teckchandani, Fremont, CA (US); Ravi Kumar Koppula, Cupertino, CA (US); Albert Calpito, JR., San Jose, CA (US); Kailasnath Dornadula, Fremont, CA (US); Nikita Krishnarao Varat, Fremont, CA (US)

(21) Appl. No.: 15/595,916

(22) Filed: May 15, 2017

Related U.S. Application Data
(60) Provisional application No. 62/337,838, filed on May 17, 2016.

(51) Int. Cl. H04W 68/00; H04L 29/06; G06F 9/54; H04M 1/725; H04W 52/02; H04W 4/00

(52) U.S. Cl. CPC H04W 68/005; H04W 52/0251; H04W 4/008; G06F 9/542; H04M 1/72569; H04L 63/083; H04W 4/003

(57) ABSTRACT

The disclosure includes facilitating transmission of event based notifications to devices. As an example, a method comprises generating, by a system operatively coupled to a processor, a set of event data based on an occurrence of one or more event; and transmitting, by the system, a subset of event data to an application executing on a second device. The method can further comprise a second subset of event data based on a help button of the first device being triggered, wherein the second subset of event data is configured to notify the application executing on the second device of the help button being triggered. The method can comprise generating a third subset of event data based on a sensor of the first device being triggered, wherein the third subset of event data is configured to notify the application executing on the second device of the sensor being triggered.

### PRIORITY CLAIM

This application claims priority to U.S. Provisional Patent Application No. 62/337,838 filed on May 17, 2016, and entitled “Swift Alert Devices, Methods, and Systems”. The entirety of the aforementioned application is incorporated by reference herein.

### BACKGROUND

A majority of the population use smart phones for a variety of purposes and in doing so smartphone users often employ applications executing on such devices. Smartphones are highly useful and users are becoming ever more dependent on them in their daily lives. The increase in smartphone ownership and user dependence on such devices for a wide range of uses has lead to a widespread use of smartphones in people's daily lives. As such, users tend to operate smartphones throughout the day which in turn consumes a significant amount of battery power in performing its operations and executing instructions. Accordingly, there is a need to be able to manage smartphone energy. Furthermore, the usability of smartphone devices is dependent on the energy efficiency and optimal management of power consumption of such devices.

Some battery management techniques attempt to place the smartphone in a power saving mode to save energy, however, the smartphone still utilizes time and energy to launch an application in power save mode or needs to transition out of power save mode before launching the application, which takes significant time and effort. Given such power consumption issues, various smartphones can operate inefficiently due to power constraints or inefficient power modes. For instance, if a user depends on the smartphone for personal safety purposes then a low battery or power constraint of the smartphone can render such personal safety tool inaccessible to the user at a time of need. As such, there is a need to resolve the issues presented above.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that facilitate an interaction between a set of agent components and execution of contracts between a subset of agent components.

According to an embodiment, a system is provided. The system comprises a processor that executes computer executable components stored in memory. The computer executable components include a generation component that generates, by a first device, a set of event data based on an occurrence of one or more event. Further, the computer executable components include a communication component that transmits, by the user device, a subset of event data to an application executing on a second device. In an aspect, the computer executable components can also include a testing component that generates a first subset of event data based on a test button of the first device being triggered, wherein the first subset of event data is configured to notify the application executing on the second device of an occurrence of a pairing between the first device and the second device.

According to another embodiment, a computer-implemented method is provided. The computer-implemented method can comprise generating, by a system operatively coupled to a processor, a set of event data based on an occurrence of one or more event. The computer-implemented method can also comprise transmitting, by the system, a subset of event data to an application executing on a second device. In an aspect, the computer-implemented method can also comprise generating, by the system, a first subset of event data based on a test button of the first device being triggered, wherein the first subset of event data is configured to notify the application executing on the second device of an occurrence of a pairing between the first device and the second device.

According to yet another embodiment, a computer program product for transmitting notification messages based on a generation of event data is provided. The computer program product can comprise a computer readable storage medium having program instructions embodied therewith, the program instructions executable by a processor to cause the processor to generate a set of event data based on an occurrence of one or more event. The computer program product can also cause the processor to transmit a subset of event data to an application executing on a second device. In an aspect, the computer program product can also cause the processor to configure the first device to establish or adjust a time interval for sending one or more messages by the first device to the second device.

### BRIEF DESCRIPTION OF THE DRAWINGS

FIG. 1 illustrates a block diagram of an example, non-limiting system that can generate event data and transmit notification messages based on the generation of event data in accordance with one or more embodiments described herein;

FIG. 2 illustrates a block diagram of an example, non-limiting system that can generate event data based on a triggering of one or more device button in accordance with one or more embodiments described herein;

FIG. 3 illustrates a block diagram of an example, non-limiting system that can configure the first device from a second device in accordance with one or more embodiments described herein;

FIG. 4 illustrates a block diagram of an example, non-limiting system that can match an identity associated with the first device with one or more identities associated with one or more other devices in accordance with one or more embodiments described herein;

FIG. 5 illustrates a flow diagram of an example, non-limiting computer-implemented method that facilitates a generation of event data and transmit notification messages based on the generation of event data in accordance with one or more embodiments described herein;

FIG. 6 illustrates a flow diagram of an example, non-limiting computer-implemented method that facilitates a generation of event data based on a test button of the first device being triggered and transmit notification messages based on the generation of event data in accordance with one or more embodiments described herein;

FIG. 7 illustrates a flow diagram of an example, non-limiting computer-implemented method that facilitates a generation of event data based on a help button of the first device being triggered and transmit notification messages based on the generation of event data in accordance with one or more embodiments described herein;

FIG. 8 illustrates a flow diagram of an example, non-limiting computer-implemented method that facilitates a generation of event data based on a sensor of the first device being triggered and transmit notification messages based on the generation of event data in accordance with one or more embodiments described herein;

FIG. 9 illustrates a flow diagram of an example, non-limiting computer-implemented method that enables the first device to transmit reoccurring update data to an application executing on a second device in accordance with one or more embodiments described herein;

FIG. 10 illustrates a flow diagram of an example, non-limiting computer-implemented method that facilitates a configuration of the first device from an application executing on a second device in accordance with one or more embodiments described herein;

FIG. 11 illustrates a block diagram of an example, non-limiting operating environment in which one or more embodiments described herein can be facilitated.

FIG. 12 illustrates a block diagram representing an exemplary non-limiting computing system or operating environment in which the various embodiments may be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

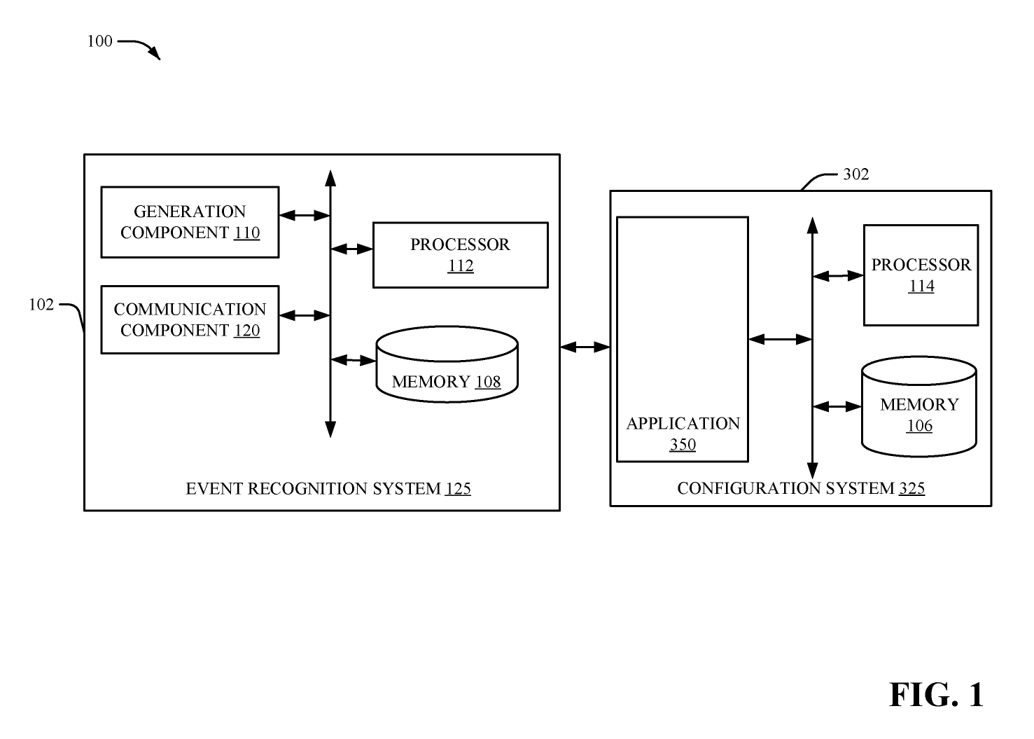

FIG. 1 illustrates a block diagram of an example, non-limiting system 100 that can generate event data and transmit notification messages based on the generation of event data in accordance with one or more embodiments described herein.

In an aspect, system 100 can include or otherwise be associated with one or more processor 112 that can execute the computer executable components and/or computer instructions stored in memory 108. In an aspect, system 100 can comprise event recognition system 125 comprising generation component 110 and communication component 120. In another aspect, system 100 can include device 102 that can employ event recognition system 125. In an aspect, one or more of the components of system 100 (e.g., event recognition system 125 components) can be electrically and/or communicatively coupled to one or more devices (e.g., device 102) of system 100 or other embodiments disclosed herein.

In an aspect, device 102 can be a hardware device, such as a key fob, that can include authentication credentials capable of controlling and securing access to networked systems, network devices, network applications and one or more data sets. In an aspect, device 102 can include a battery indicator light and a data light. In an aspect, the battery indicator light can illuminate (e.g., a green color) to identify whether a battery that provides power to device 102 is charged (e.g., battery indicator light illuminates a first color, such as green, continuously to indicate device 102 has a sufficient or ok charge), nearing an end of its charge (battery indicator light illuminates a different second color, such as red to indicate the battery needs to be charged), or indicates a transmission of data when it flashes (e.g., battery indicator light flashes when data is transmitted from device 102 to another recipient device). In another aspect, device 102, can include a data light to indicate whether device 102 is tethered (e.g., connected over a network) to a recipient device, such as a mobile device (e.g., device 302 described below). In an aspect, the data light can illuminate a first color such as green (e.g., indicating a network connection to a recipient device has occurred such that the devices are wirelessly connected), illuminate a second color different from the first color such as red (e.g., indicating that the device 102 is not connected to a recipient device and can connect if properly paired to the recipient device), flashing a first or second color (e.g., indicating device 102 is transmitting data to a recipient device). In yet another aspect, both the battery indicator light and the data light can illuminate and blink at a defined interval in order to indicate that device 102 is paired to another device. This blinking can occur continuously at the defined interval so long as device 102 is paired to another device (e.g., device 302).

In another aspect, device 102 can comprise a “I am ok” button (also referred to as test button in some instances) and/or a help button. In an aspect, the “I am ok” button of device 102 can be triggered (e.g., user depressing the button as a triggering event) and in response to such triggering event, processor 112 can execute a generation component 110 of event recognition system 125. In an aspect, generation component 110 can generate a set of event data based on an occurrence of one or more event. For instance, the triggering of an “I am ok” button can be an occurrence of an event such that generation component 110 generates test button event data. In another aspect, processor 112 can execute a communication component 120 that can transmit a subset of event data (e.g., test button event data) to a first application (e.g., application 350 described below) executing on a second device (e.g., device 302 described below). In an aspect, the first application (e.g., application 350) executing on a second device (e.g., device 302) can facilitate a configuration of device 102. In another aspect, the functionality associated with device 102 can contribute to the power saving aspects of smart phones in that the first application (e.g., application 350) executing on a second device (e.g., a smart phone) can execute operational functions associated with application 350 even while device 302 is set to power save mode causing device 302 to utilize less power and sacrifice various operational functions that correspond to a device 302 not set to power save mode.

As such, an application (e.g., application 350) executing on a second device (e.g., device 302) can still perform several tasks and functions associated with and/or in conjunction with device 102 (e.g., facilitating a transmission of generated event data from device 102) while the smart phone is conserving its battery life. Also, device 102 performs several tasks associated with generation component 110 (e.g., generating event data) and communication component 120 (e.g., transmitting generated event data) that do not require the use of a second device battery power. As such, a user can still monitor its personal safety by using device 102 and obtain various personal safety benefits on its smart phone while simultaneously conserving the battery life of the smart phone. In an aspect, an application (e.g., application 350) executing on a second device (e.g., smart phone) facilitates second device 302 processor (e.g., processor 114) efficiencies in that several tasks can occur while the second device 302 is in power save mode and allow the processor (e.g., processor 114) to execute components and instructions in an expedited manner.

Furthermore, device 102 bears the load of several tasks that do not draw from the battery life of the second device 302 (e.g., smart phone) which facilitates a preservation of battery life and power in second device 302. In another aspect, processor 112 of device 102 also executes tasks and instructions that demonstrates processor 112 efficiencies. In a non-limiting embodiment, processor 112 can rely on device 302 to process a set of instructions and perform a set of tasks that facilitates a transmission of event data such that processor 112 does not have to be inundated with such tasks. Also, in another aspect, the event data generated (e.g., using generation component 110) by device 102 can be easily transmitted due such data comprising access patterns that allow such data to be accessed efficiently and in an expedited manner from cache and/or memory 108.

In an aspect, the subset of event data can represent identification data that indicates the identity of device 102 (e.g., serial number of the device, authentication token, identification signature, etc.) and authenticity of data generated, modified, and/or transmitted by device 102. For instance, the subset of event data can be labeled or uniquely identified to have originated from device 102 and thus convey authenticity to the data as being sourced from device 102. In an aspect, event data can represent information regarding events that occurred (e.g., triggering event) in association with device 102. For instance, device 102 can generate data in response to a pushing (e.g., by a user) of a “I am ok” button (also referred to as a test button) or help button. Furthermore, device 102 can generate data in response to an accelerometer component of device 102 sensing a change in orientation or acceleration of device 102. For instance, if device 102 falls to the floor, the accelerometer will sense the change in acceleration and generate data (e.g., using generation component 110) associated with the falling event.

In another aspect, the “I am ok” button of device 102 can be triggered (e.g., user pushes button) in order to initiate a transmission of an electronic signal to another network device (e.g., mobile device such as device 302 described below). Accordingly, the “I am ok” button of device 102 allows for device 102 to become discoverable by other network devices (e.g., smartphones, tablets, computers, laptops, set top boxes, servers, base station, etc.). Thus, in an aspect, a triggering of the “I am ok” button can constitute an event such that generation component 110 can generate test button event data associated with such “I am ok” button triggering. In yet another aspect, the “I am ok” button of device 102 can be triggered and test data can be generated (e.g., using testing component 210) to verify that event recognition system 125 is operational. In another aspect, device 102 can execute (e.g., using processor 112) a generation task that generates (e.g., using generation component 110) help data based on a triggering (e.g., by a user possessing device 102) of a help button of device 102.

In another aspect, the help data can be transmitted (e.g., using communication component 120) to another recipient device (e.g., device 302 or other authorized devices pursuant to data input entered using first configuration component 320) to indicate the occurrence of the help button triggering event. In an aspect, the help button can be triggered (e.g., by a user possessing device 102) to transmit alerts to recipient devices indicated in a list (e.g., a list of recipient devices populated using first configuration component 310 of an application 350 executing on device 302). In another aspect, a user possessing device 102 can indicate that everything is ok by executing application 350 on device 302 and inputting and/or generating data (e.g., by pressing an “I am ok” button presented on a device 302 executing application 350). In an aspect, an “I am ok” button can be presented at device 302 user interface and such button can be held for a short period of time (a few seconds) to indicate (e.g., transmitting a notification message) to authorized recipient devices that everything is ok with the possessor of device 102.

In an aspect, processor 112 can execute communication component to transmit test data and/or help data to a first application (e.g., application 350 described below) executing on another device (e.g., device 302 described below). Accordingly, the generated (e.g., using generation component 110) event data can be utilized by other devices for purposes of processing, conducting additional tasks (e.g., configuring device 102 or event recognition system 125), integrating event data with other types of data (e.g., other application data executing on a mobile device such as device 302), and other such purposes. In another aspect, device 102 can include a power button to power on and power off device 102. In yet another aspect, device 102 can include a charging port (e.g., USB port) facilitating device 102 to connect to a USB wire or outside charging mechanism (e.g., connecting to a laptop, electrical outlet, etc.) from which device 102 can charge its battery.

In another non-limiting embodiment, device 102 can comprise a help button and an “I am ok” button (described above). In an aspect, if the help button is triggered on device 102 (e.g., user pushes the help button) then a notification (e.g., alert via alert data or notification data) can be transmitted to an application (e.g., supplication 350 described below) executing on another device (e.g., device 302) or to a server device (e.g., device 402). Upon transmission of the notification data, representing the need for help by a user possessing device 102, the device 302 or device 402 can transmit the notification data to authorized devices (e.g., emergency providers, friends, family, employer, etc.) to facilitate a provisioning of assistance to the possessor of device 102. Furthermore, in another aspect, device 302 or device 402 can initiate the generation of notification data based on receipt of data indicating a help button and/or “I am ok” button is triggered on device 102. In an aspect, device 102 can generate (e.g., using generation component 110) nullification data that represents a possessor of device 102 is in no need of assistance or is “ok”. For instance, after help data is triggered (e.g., user presses help button) on device 102, nullification data can subsequently be generated (e.g., using generation component 110) based on a triggering of an “I am ok” button (e.g., user pushes “I am ok” button) on device 102. Accordingly, nullification data can be transmitted to intermediary devices and further along to authorized user devices to communicate that no assistance is needed to the possessor of device 102.

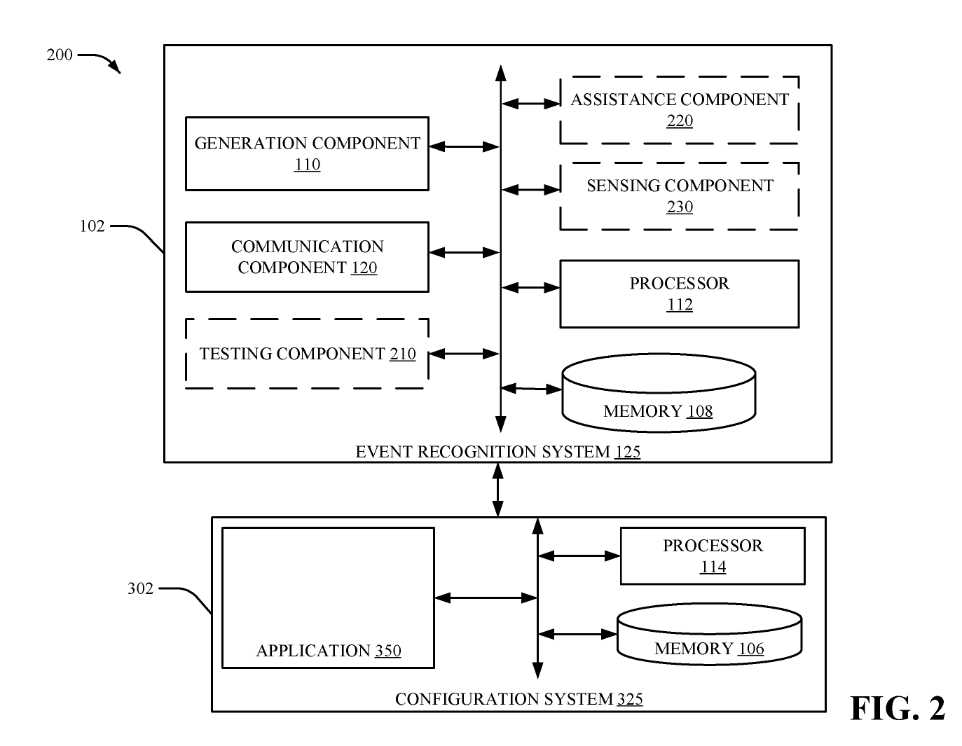

Turning now to FIG. 2, illustrated is a block diagram of an example, non-limiting system 200 that can generate event data based on a triggering of one or more device button in accordance with one or more embodiments described herein. In an aspect, system 200 can include or otherwise be associated with one or more processor 112 that can execute the computer executable components and/or computer instructions stored in memory 108. In an aspect, system 200 can comprise event recognition system 125 comprising generation component 110 and communication component 120. In another aspect, system 200 can include device 102 that can employ event recognition system 125. In yet another aspect, system 200 can include testing component 210, assistance component 220, and sensing component 230. In an aspect, one or more of the components of system 200 (e.g., event recognition system 125 components) can be electrically and/or communicatively coupled to one or more devices (e.g., device 102) of system 200 or other embodiments disclosed herein.

In an aspect, system 200 can employ processor 112 to execute testing component 210 that generates a first subset of event data based on a test button of the first device being triggered, wherein the first subset of event data is configured to notify the application executing on the second device of an occurrence of a pairing between the first device and the second device. In an aspect, processor 112 can execute generation component 110 in connection with test component 210 to generate test data in response to a triggering of the test button. The test data can be transmitted (e.g., using communication component 120) to application (e.g., application 325) executing on a second device (e.g., device 302). In an aspect, the application (e.g., application 325) executing on device 302 can confirm the receipt of the test data. For instance, upon a receipt of the test data at device 302, application 350 can present a notification (e.g., using a notification component) at a user interface of device 302 of the locating of device 302 by device 102.

In another aspect, system 200 can employ an assistance component 220 that generates a second subset of event data based on a help button of the first device being triggered, wherein the second subset of event data is configured to notify the application executing on the second device of the help button being triggered. In an aspect, processor 112 can execute generation component 110 in connection with assistance component 220 to generate test data in response to a triggering of the “I am ok” button on device 102. The help data can be transmitted (e.g., using communication component 120) to application (e.g., application 325) executing on a second device (e.g., device 302). In an aspect, the application (e.g., application 325) executing on device 302 can confirm the receipt of the help data and utilize the help data to perform additional tasks. For instance, upon a receipt of the help data at device 302, application 350 can present a notification (e.g., using a notification component) at a user interface of device 302 of the receipt of help data from device 102.

In an aspect, upon a receipt of help data by application 350, application 350 can perform tasks such as transmitting a notification of the help data to other devices (e.g., transmitting data to system components executing on other devices) in order to garner assistance related to the reason the help button was triggered. For example, in an aspect, a user of device 102 can be a telecommunication maintenance worker. In some instances, such user may work alone and in remote areas such that they are vulnerable to not receiving assistance or being able to notify others of an occurrence of an injury while working. Accordingly, such user can carry device 102 to such remote locations while working alone to have the capability of notifying authorized recipients of an occurrence of an injury. In the event the worker encounters an emergency situation or an accident, they can press the help button and generation component 110 in connection with assistance component 220 can generate help data.

Furthermore, in an aspect, assistance component 220 executing (e.g., using processor 112) on device 102 can transmit a signal or help data to the workers' application (e.g., application 350) executing on his mobile phone (e.g., device 302) where the application triggers the phone to transmit a message or the help data to a designated other device (e.g., family member device, emergency service provider device, employer device, etc.). Thus, if a physical injury (e.g., the worker falls gets stuck in mechanical equipment while fixing a telephone tower) occurs to the worker or a medical emergency that suddenly occurs, then device 102 allows for a quick help message and/or help data to be transmitted to an authorized responder or device.

In another aspect, system 200 can employ a sensing component 230 that generates a third subset of event data based on a sensor of the first device 102 being triggered, wherein the third subset of event data is configured to notify the application (e.g., application 350) executing on the second device (e.g., device 302) of the sensor being triggered. In an aspect, device 102 can include a sensing component 230 that generates sensor data (in connection with generation component 110) in accordance with the triggering of a sensor. For instance, device 102 can include an accelerometer sensor that can facilitate the detection of the orientation of device 102. In another embodiment, device 102 can include a gyroscope sensor that facilitate the detection of the rotation or twist of device 102. In an instance, the subset of event data generated by sensing component 230 can include the following data associated with device 102: orientation data, rotational data, twist data, angular velocity data, linear acceleration data, movement data, rate of change data (of movement, twist, rotation, velocity, etc.), directional movement data, tilt data, lateral orientation data.

In another embodiment, device 102 can include a digital compass sensor that utilizes a magnetometer to facilitate an identification of device 102 orientation in relation to a magnetic field of planet Earth. In a non-limiting example, sensing component 230 in connection with a sensor within device 102 can generate sensor data associated with device 102 falling. For instance, if device 102 fell a distance of 50 feet, such fall distance can be reflected in acceleration data (e.g., greater acceleration), rotational data (e.g., device 102 incurs more rotations and/or revolutions), angular velocity data (e.g., whether the fall is a straight drop to the ground or perhaps an arching fall), orientation data (e.g., whether the device 102 fell directly South or perhaps South East or Southwest), vibrational data, positional data, and other such sensor data. In an aspect, the data can be used to identify whether the device 102 and the user possessing device 102 has suffered a fall and/or perhaps an injury. For instance, sensing component 230 can sense (e.g., using device 102 sensors) whether a fall has occurred by a user possessing device 102 based on an evaluation of generated sensor data (e.g., using sensing component 230). Furthermore, in an aspect, device 102 can transmit (e.g., using communication component 120) event data and notification data alerting one or more authorized recipient device that a fall has occurred and the possessor of device 102 may need assistance.

The generated (e.g., using sensing component 230) can be transmitted to device 302 or other such device in order to properly reach those that can provide assistance (e.g., family member, employer, emergency service provider, etc.) to the user in possession of device 102. In yet another aspect, if an elderly person in possession of device 102 suffers from a fall or injury, the generated sensor data can provide the data to proper individuals in position to assist the fallen person. In another aspect, sensor data can be generated (e.g., using sensing component 230) subsequent to an event a jolting event as well. For instance, after a large fall, the accelerometer sensor and gyroscope sensor can detect little or no movement of device 102. In an aspect, the lack of movement for a time period after the generation of acceleration data above a threshold acceleration level can indicate that the user in possession of device 102 could be injured or harmed, which may trigger correspondence component 120 to transmit a notification message to an emergency responder in preparation to tend to an injury of the user in possession of device 102.

Furthermore, in an aspect, the generated sensing data (e.g., using sensing component 120) can facilitate a determination of whether a sensor based event that occurs is likely to have been an event that should require an emergency response or a dismissal of the event. For instance, device 102 can be configured to trigger the transmission of generated sensor data if the sensor data satisfies or is greater than a threshold value associated with the sensor data. For instance, if the sensor data represents information that deems device 102 fell a distance of two feet (e.g., determined from acceleration data, velocity data, twist data, etc.) and there is a threshold distance of five feet required for device 102 to fall in order to trigger a transmission of data, then the data may not be transmitted to another device according to such example configuration. Furthermore, a threshold value can be represented as a numerical digit. For instance, a subset of sensor data can be assigned a value (e.g., between 1 and 10) and if such value falls below or above a configured threshold value (e.g., 5) then the generated sensor data may or may not be transmitted to another device.

In another aspect, system 200 can employ processor 112 to execute communication component 220 to transmit the first subset of event data, a second subset of event data, or a third subset of event data to the application executing on the second device. For instance, communication component 220 can transmit the generated data (e.g., generated in part or in whole by generation component 110) including sensor data (e.g., generated using sensing component 230), help data (e.g., generated using assistance component 220), test data (e.g., generated using testing component 210). As such communication component 120 can transmit a variety of data associated with device 102 to a second device (e.g., device 302).

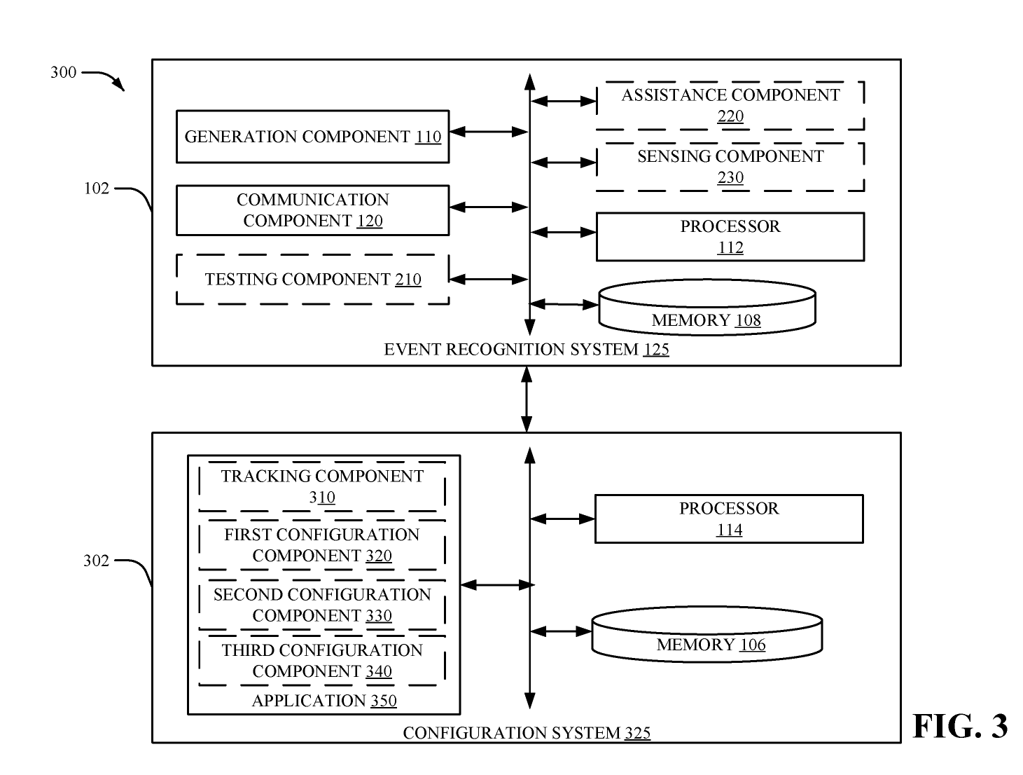

Turning now to FIG. 3, illustrated is a block diagram of an example, non-limiting system 300 that can generate event data based on a triggering of one or more device button in accordance with one or more embodiments described herein. In an aspect, system 300 can include or otherwise be associated with one or more processor 112 that can execute the computer executable components and/or computer instructions stored in memory 108. In an aspect, system 300 can comprise event recognition system 125 comprising generation component 110 and communication component 120. In another aspect, system 300 can include device 102 that can employ event recognition system 125. In yet another aspect, system 300 can include testing component 210, assistance component 220, and sensing component 230.

In another aspect, system 300 can comprise configuration system 325 employed by device 302. In an aspect, configuration system 325 can include or otherwise be associated with one or more processor 114 that can execute the computer executable components and/or computer instructions stored in memory 106. In another aspect, configuration system 325 can comprise application 350 which can include tracking component 310, first configuration component 320, second configuration component 330, and third configuration component 340. In an aspect, one or more of the components of system 300 (e.g., event recognition system 125 components) can be electrically and/or communicatively coupled to one or more devices (e.g., device 102) of system 300 or other embodiments disclosed herein.

In an aspect, system 300 can employ processor 114 to execute the first application (e.g., application 350) executing on the second device (e.g., device 302) comprising a tracking component 310 that enables the first device to transmit reoccurring update data to the application (e.g., application 350) executing on the second device (e.g., device 302). In an aspect, device 302 can comprise one or more network device (e.g., smartphones, tablets, computers, laptops, set top boxes, servers, base station, etc.). In an aspect, processor 114 can execute tracking component 310 that can track a range of data associated with device 102 including sensor data, test data, help data, power data (e.g., battery charge information, on/off information, etc.), device 102 use data, and other such data. In an aspect, tracking component can track the data for analytical use and such data transmitted from device 102 to device 302 (or other such device) can be represented in numerous data representations.

Furthermore, in an aspect, tracking component 310 can facilitate a tracking of a user location upon occurrence of an event, triggering of a button on the device, or generation of event data. As an example, if data generated by a component (e.g., sensing component 230 or assistance component 220) indicates that a user possessing device 102 may have fallen or become injured, then tracking component 310 can periodically track the location of device 102. In an aspect, the tracking (e.g., using tracking component 310) can occur by a user possessing device 102 triggering a help button or “I am ok” button on a reoccurring basis and/or a generation and transmission of GPS data associated with device 102 (e.g., using a GPS sensor included within device 102). Thus, a recipient device can receive location data (e.g., periodic alert tracking information) associated with device 102 and know where the possessor of device 102 is located at a given time.

In another aspect, the data generated by device 102 can be represented in a variety of formats once received by application 350 of device 302. For instance, the data can be represented in a raw format (e.g., hexadecimal data, binary data, denary data, numerical data), graphical representation (e.g., diagrams, distribution charts, histograms, graphs, scatter graph, stem and leaf diagrams, etc.), textual representations, audio representations, image representations, and/or video representations such that activities associated with device 102 can be organized, characterized, classified, ranked and sorted in meaningful ways to assist with various data evaluations. As an example, an employer whom distributes one or more device 102 to its employees can track data associated with injuries or damage incurred to workers while possessing device 102 on the job.

Accordingly, the employer can evaluate and/or review the data (in various formats such as graphical formats) to determine the tasks and activities that are correlated with more injuries, safety precautions that tend to mitigate injuries (e.g., reviewing data before and after implementation of a safety policy or protocol), the response time to respond to injuries, and other such data. Furthermore, in an aspect, such data can be utilized by a third party insurance provider whom provides insurance policies to employers that cover workplace injuries for instance. The insurer can utilize data associated with device 102 to quantify risk and develop a customized insurance policy that is cost-efficient and covers those most frequent risks and/or injuries that occur. The data can even be evaluated as part of the insurers underwriting criteria. Thus, the data from device 102 can be tracked by tracking component 310 and represented in several formats. Furthermore, in an aspect, the tracking component 310 can facilitate a reoccurring update of the data transmitted (e.g., using communication component 120) by device 102 to the application 350 executing on device 302 (or another device).

In another aspect, configuration system 325 can employ processor 114 to execute application 350 in connection with first configuration component 320 that configures the first device (e.g., device 102) to establish or adjust a time interval for sending one or more messages by the first device to the second device (e.g., device 302). In an aspect, first configuration component 320 executing on application 350 of device 302 can facilitate configuration of device 102 in a range of respects. For instance, first configuration component 320 can facilitate the identification of user-related customizations (e.g., user settings) to device 102 including user basic information (e.g., name, phone number, address, notes, etc.). In an aspect, first configuration component 320 configuration of user settings can facilitate an assignment of an identity to device 102 beyond a serial number identifier. As such, the user possessing device 102 can be a user undergoing the activities to be tracked by device 102 and for some activities, data associated with such activities can be transmitted to other devices (e.g., devices possessed by employers, family members, friends, emergency responders, call centers, etc.). Upon the transmission of such data related to device 102, the recipient of such data, notifications, or messages will benefit from knowing the identity of the user associated with device 102 data and thus the user setting configurations are useful for device 102.

In another aspect, processor 114 can execute first configuration component 320 to configure notification settings associated with device 102. For instance, first configuration component 320 can allow a user to input data at a user interface of device 302 presented using application 350, where such input data comprises one or more recipient device (e.g., smart phone possessed by family member, employer, emergency service provider) for notifying or sending data generated by device 102. The input data can comprise the possessor of the one or more recipient device name, identifier (e.g., phone number), whether the recipient device can receive tracking data (e.g., generated using tracking component 310 executing on application 350 of device 302), a number of message to send to such recipient device and within a time interval specified in minutes (e.g., 15-minute span).

For instance, first configuration component 320 can configure a five messages (e.g., total number of messages) to be transmitted (e.g., using communication component 120) from device 102 to a specified recipient device (e.g., smart phone number identified by first configuration component 320) in a span (e.g., time interval) of thirty minutes. In an aspect, first configuration component 320 can facilitate an adjustment of the recipient device (e.g., changing a phone number to represent a different authorized recipient device), total message to transmit, and the time interval duration. Furthermore, first configuration component 320 can facilitate a transmission of event data associated with device 102 to more than one recipient device (e.g., five users can be notified or alerted of activity associated with device 102, or receive event data related to device 102 activity).

In another aspect, first configuration component 320 can facilitate a pairing between device 102 and device 302. In an aspect, application 350 can present a pairing button (e.g., using first configuration component 320) at a user interface of device 302. A user of device 302 can press the pairing button and device 102 can appear from a list of one or more devices. Upon selection (e.g., using first configuration component 320) of device 102 from the list, device 102 and device 302 can pair with one another or tether with one another. In an aspect, the pairing between device 102 and device 302 can indicate that data can be transmitted between both devices and that device 302 (e.g., using supplication 350 executing first configuration component 320) can configure device 102.

In an aspect, system 300 can employ first application 350 to execute (e.g., using processor 114) a second configuration component 330 that configures the first device to establish or adjust an amount of messages to send by the first device (e.g., device 102) to the second device (e.g., device 302) within the time interval. In an aspect, first configuration component 320 can configure the number of message to be transmitted to device 102 upon generation and receipt (e.g., from device 102) of event data. Furthermore, in an aspect, second configuration component 330 can facilitate a configuration of device 102 to transmit the total amount of messages (e.g., established by first configuration component 320) within a customized time interval. Furthermore, in an aspect, the communication component 120 can transmit the amount of messages at an established frequency or an adjusted frequency within the time interval based on one or more configurations established by the first configuration component 320 and/or the second configuration component 330.

For instance, as a non-limiting example, device 102 can be configured to transmit a total number of one message within a first interval of one minute or a second interval of fifteen minutes. In the former instance, a message (e.g., conveying location data, etc.) can be transmitted from device 102 to an authorized device every sixty seconds and in the latter instance a message is transmitted to the authorized device every minute for a period of fifteen minutes. The time interval is based on user input and a user preference and can be customized using second configuration component 330. At any instance, device 102 can transmit data to indicate the status of device 102 (e.g., and the possessor of device 102) is in ok condition based on a pressing of an “ok” button presented at a user interface of device 302 using application 350.

In another aspect, system 300 can employ application component 350 to execute (e.g., using processor 114) a third configuration component 340 that configures the first device (e.g., device 102) to establish or adjust a check-in requirement on the first device (e.g., device 102), wherein a triggering data must be deployed by the first device in response to a check-in message generated by the application (e.g., application 350) executed on the second device (e.g., device 302). In an instance, third configuration component 340 can configure device 102 to check-in (e.g., generate check-in data) by generating check-in data at device 302 (e.g., user pressing an “I am ok” button on a user interface presented by application 350 on device 302). In an aspect, such check-in requirement can be configured (e.g., using third configuration component 340) to require the receipt of check-in data during an established time interval (e.g., pursuant to third configuration component 340). For instance, device 102 can be configured (e.g., using third configuration component 340) to require a user possessing device 102 to press help button on device 102 once every three minutes or require a user possessing device 302 press “I am ok” button on device 302 every three minutes in order to satisfy the requirements of the time interval configured by third configuration component 340.

In another aspect, a check-in requirement can be utilized such that device 302 can establish a timing (e.g., twice a day, once at noon and again at 6:00 pm) that requires device 102 to generate data indicating the user or possessor of device 102 is okay. In an aspect, device 102 can generate (e.g., using generation component 110) and transmit (e.g., using correspondence component 120) data associated with a triggering of the “I am ok” button on device 102 to indicate that a user of device 102 is okay in response to the check-in notification. If device 102 does not generate data associated with the triggering of the “I am ok” button in response to a check-in notification received at device 302, then a notification can be transmitted to an authorized person to provide assistance to the user or possessor of device 102. For instance, the family of an elderly person may establish a check-in timer that requires the elderly person to press an “I am ok” button (e.g., located on device 102) in response to receiving a check-in notification at device 302. If the elderly person does not push the “I am ok” button then emergency assistance can be sent to the elderly person (e.g., using location of device 102 information). In another aspect, a user of device 102 can be an employee required to respond to a check-in timer at a regular interval while working at a remote location. Accordingly, if the employee owner of device 102 does not push the “I am ok” button on device 102 in response to a check-in notification received at device 302, then emergency assistance can be sent to the location of device 102 (e.g., where the employee in possession of device 102 is located). In an aspect, device 102 decouples functionality associated with providing safety and security to a user, owner, or possessor of device 102 such that device 302 can save battery power and energy and operate an application associated with device 102 even in power saving mode. Thus, a user of device 102 can save battery power on device 302 (e.g., keep a mobile phone in power saving mode) and the application component 350 associated with device 102 can still be operational and features be accessible by device 302.

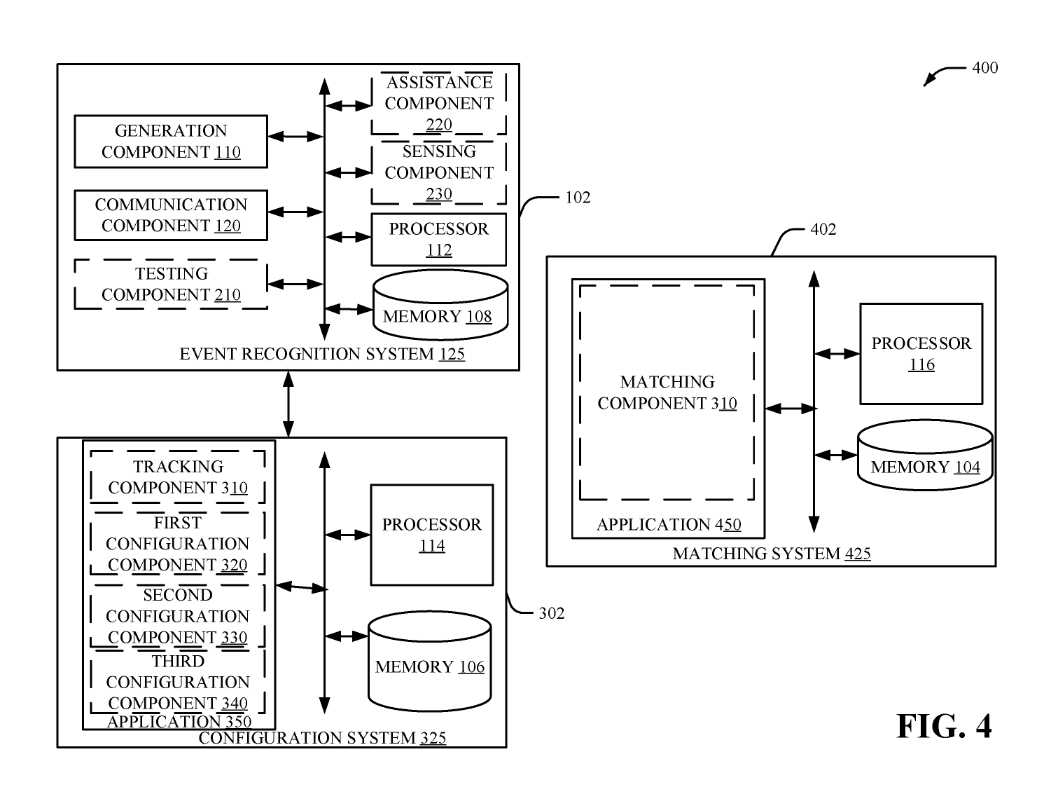

Turning now to FIG. 4, illustrated is a block diagram of an example, non-limiting system 400 that can match (e.g., using matching component 310) an identity associated with the first device (e.g., device 102) with one or more identities associated with one or more other devices (e.g., device 302 and device 402) in accordance with one or more embodiments described herein. In an aspect, system 400 can include or otherwise be associated with one or more processor 112 that can execute the computer executable components and/or computer instructions stored in memory 108. In an aspect, system 400 can comprise event recognition system 125 comprising generation component 110 and communication component 120. In another aspect, system 400 can include device 102 that can employ event recognition system 125. In yet another aspect, system 400 can include testing component 210, assistance component 220, and sensing component 230.

In another aspect, system 400 can comprise configuration system 325 employed by device 302. In an aspect, configuration system 325 can include or otherwise be associated with one or more processor 114 that can execute the computer executable components and/or computer instructions stored in memory 106. In another aspect, configuration system 325 can comprise application 350 which can include tracking component 310, first configuration component 320, second configuration component 330, and third configuration component 340. In an aspect, one or more of the components of system 400 (e.g., event recognition system 125 components) can be electrically and/or communicatively coupled to one or more devices (e.g., device 102) of system 400 or other embodiments disclosed herein.

In an aspect, system 400 can employ processor 114 to execute the first application (e.g., application 350) executing on the second device (e.g., device 302) comprising a tracking component 310 that enables the first device to transmit reoccurring update data to the application (e.g., application 350) executing on the second device (e.g., device 302). In an aspect, device 302 can comprise one or more network device (e.g., smartphones, tablets, computers, laptops, set top boxes, servers, base station, etc.). In an aspect, processor 114 can execute tracking component 310 that can track a range of data associated with device 102 including sensor data, test data, help data, power data (e.g., battery charge information, on/off information, etc.), device 102 use data, and other such data. In an aspect, tracking component can track the data for analytical use and such data transmitted from device 102 to device 302 (or other such device) can be represented in numerous data representations. In another aspect, system 400 can employ processor 116 to execute the second application (e.g., application 450) executing on third device (e.g., device 425) comprising a matching component 310. In an aspect, the triggering of the help button or sensing component 230 on device 102 can commence the tracking feature (e.g., using tracking component 310) of device 102. However, a triggering of the “I am ok” button on device 102 can disable the tracking feature of device 102 as well.

In an aspect, matching system 425 (e.g., employed on device 402 such as a server device) can execute (e.g., using processor 116) matching component 310. In an aspect, device 402 can be a server, network device, mobile phone, tablet, laptop, workstation or one or more cloud-based devices. In an aspect, device 402 can employ matching component 310 to match a first identifier associated with the first device (e.g., device 102) to a set of identifiers associated with a set of authorized user devices (e.g., pursuant to input received at first configuration component 320, wherein the set of identifiers represent authorized user devices contact information for receiving the subset of event data. In an instance, first configuration component 320 can facilitate an input of information associated with authorized devices (e.g., mobile phones, etc.) to be notified or for receipt of transmitted (e.g., using communication component 120) event data in the event of an occurrence of a triggering event.

In an aspect, device 102 can also transmit event data to device 402 and matching component 310 can match such data to one or more authorized devices. For instance, if numerous devices (e.g., device 102) are distributed to several users in an organization (e.g., company) then the organization can utilize a device 402 that is a server device to manage the coordination of event data transmission associated with several authorized devices. As such, device 402 can employ application 450 to execute (e.g., using processor 116) matching component 310. In an aspect, matching component 310 can match a device (e.g., device 102) identity with authorized devices in order to transmit event data from device 102 or device 402 to such authorized devices. Furthermore, in an aspect, device 402 can transmit event data and match (e.g., using matching component 310) several (e.g., thousands) of device identities to several (e.g., thousands) authorized devices simultaneously.

In an aspect, one or more embodiment disclosed herein (e.g., system 100, system 200, system 300, system 400) can be implemented in a cloud computing environment, however, such embodiments of the present invention are capable of being implemented in conjunction with any other type of computing environment as well. In an aspect, cloud computing can refer to a model of service delivery for enabling network access in a convenient and on-demand manner. The cloud computing environment can include a shared pool of computer resources that can provide efficient (e.g., fast speed and little management requirements) interactions with a service provider. Furthermore, such computing resources can include networks, servers, processors, network bandwidth, virtual machines, services, storage, and applications.

In an aspect, a cloud model can exhibit several characteristics, employ several servicing models, and be deployed in accordance with any one or more of several deployment models. In an aspect, a cloud computing environment can have characteristics resembling an on-demand self-service character, broad network access character, resource pooling character, rapid elasticity character, and/or measured service character. In another aspect, the several embodiments disclosed herein can be provided to consumers in accordance with one or more service models that include software as a service, platform as a service, and infrastructure as a service. In yet another aspect, a cloud computing model can be deployed in one or more of several deployment models including a private cloud, a community cloud, a public cloud, and/or a hybrid cloud.

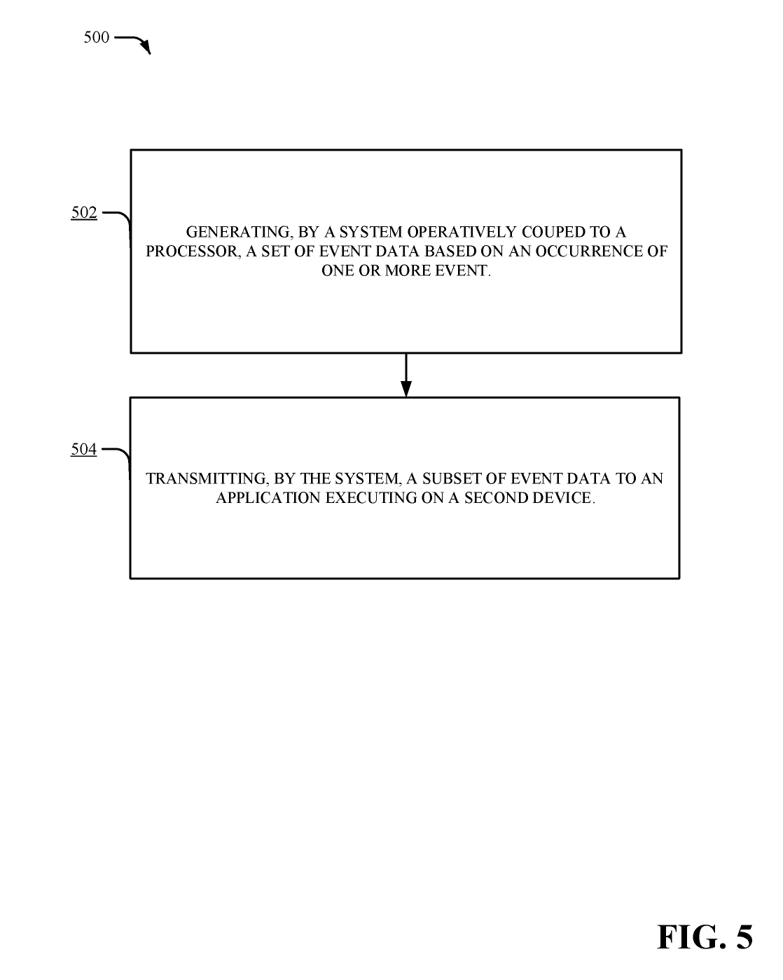

FIG. 5 illustrates a flow diagram of an example, non-limiting computer-implemented method 500 that facilitates a generation of event data and transmit notification messages based on the generation of event data in accordance with one or more embodiments described herein.

In an aspect, one or more of the components described in computer-implemented method 500 can be electrically and/or communicatively coupled to one or more devices. Repetitive description of like elements employed in other embodiments described herein is omitted for sake of brevity. In some implementations, at reference numeral 502, a system operatively coupled to a processor (e.g., processor 112) can generate (e.g., using generation component 110) a set of event data based on an occurrence of one or more event. At reference numeral 504, the system can transmit (e.g., using communication component 120) a subset of event data to an application executing on a second device.

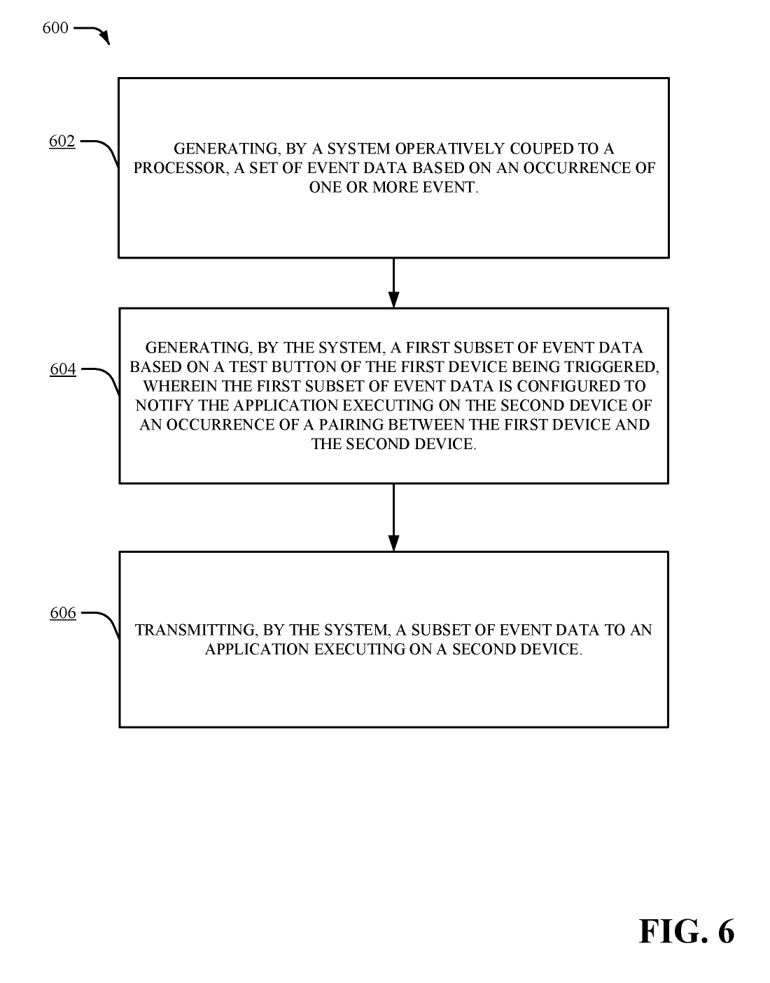

FIG. 6 illustrates a flow diagram of an example, non-limiting computer-implemented method 600 that facilitates a generation of event data based on a test button (also referred to as “I am ok” button and can be built into device 102 as an “I am ok” button) of the first device being triggered and transmit notification messages based on the generation of event data in accordance with one or more embodiments described herein.

In an aspect, one or more of the components described in computer-implemented method 600 can be electrically and/or communicatively coupled to one or more devices. Repetitive description of like elements employed in other embodiments described herein is omitted for sake of brevity. In some implementations, at reference numeral 602, a system operatively coupled to a processor (e.g., processor 112) can generate (e.g., using generation component 110) a set of event data based on an occurrence of one or more event. At reference numeral 604, the system can generate (e.g., using testing component 210) a first subset of event data based on a “I am ok” button of the first device being triggered, wherein the first subset of event data is configured to notify the application executing on the second device of an occurrence of a pairing between the first device and the second device. At reference numeral 606, the system can transmit (e.g., using communication component 120) a subset of event data to an application executing on a second device.

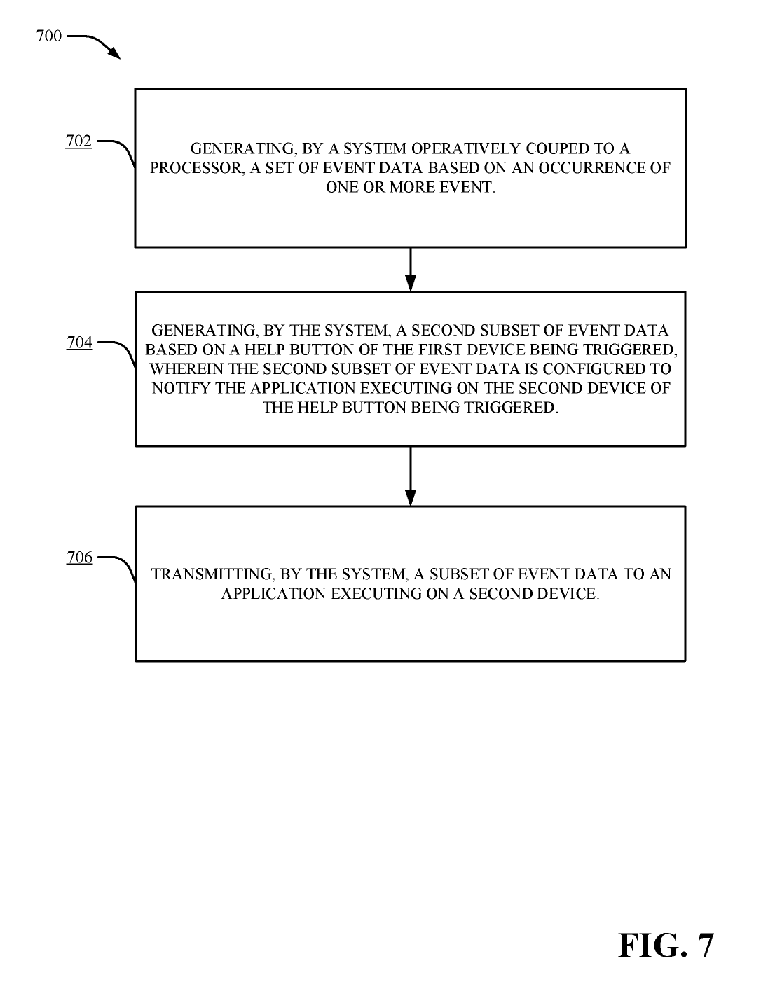

FIG. 7 illustrates a flow diagram of an example, non-limiting computer-implemented method that facilitates a generation of event data based on a help button of the first device being triggered and transmit notification messages based on the generation of event data in accordance with one or more embodiments described herein.

In an aspect, one or more of the components described in computer-implemented method 700 can be electrically and/or communicatively coupled to one or more devices. Repetitive description of like elements employed in other embodiments described herein is omitted for sake of brevity. In some implementations, at reference numeral 702, a system operatively coupled to a processor (e.g., processor 112) can generate (e.g., using generation component 110) a set of event data based on an occurrence of one or more event. At reference numeral 704, the system can generate (e.g., using assistance component 220) a second subset of event data based on a help button of the first device being triggered, wherein the second subset of event data is configured to notify the application executing on the second device of an occurrence of a pairing between the first device and the second device. At reference numeral 706, the system can transmit (e.g., using communication component 120) a subset of event data to an application executing on a second device.

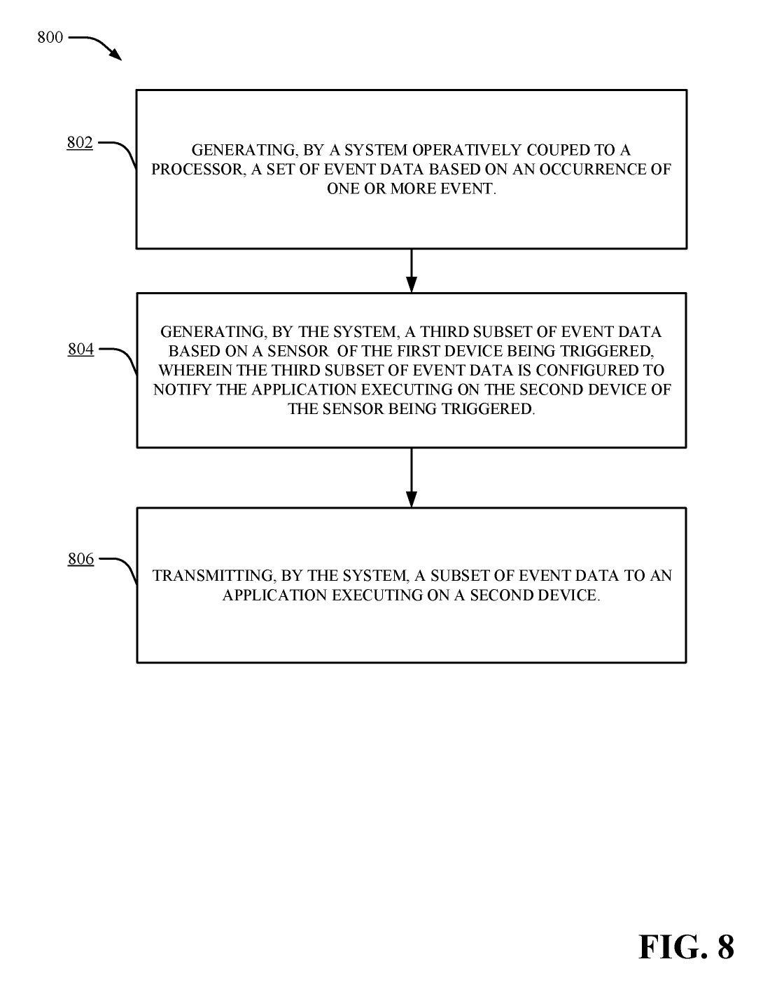

FIG. 8 illustrates a flow diagram of an example, non-limiting computer-implemented method that facilitates a generation of event data based on a sensor of the first device being triggered and transmit notification messages based on the generation of event data in accordance with one or more embodiments described herein.

In an aspect, one or more of the components described in computer-implemented method 800 can be electrically and/or communicatively coupled to one or more devices. Repetitive description of like elements employed in other embodiments described herein is omitted for sake of brevity. In some implementations, at reference numeral 802, a system operatively coupled to a processor (e.g., processor 112) can generate (e.g., using generation component 110) a set of event data based on an occurrence of one or more event. At reference numeral 804, the system can generate (e.g., using sensing component 230) a third subset of event data based on a sensor of the first device being triggered, wherein the second subset of event data is configured to notify the application executing on the second device of the sensor being triggered. At reference numeral 806, the system can transmit (e.g., using communication component 120) a subset of event data to an application executing on a second device.

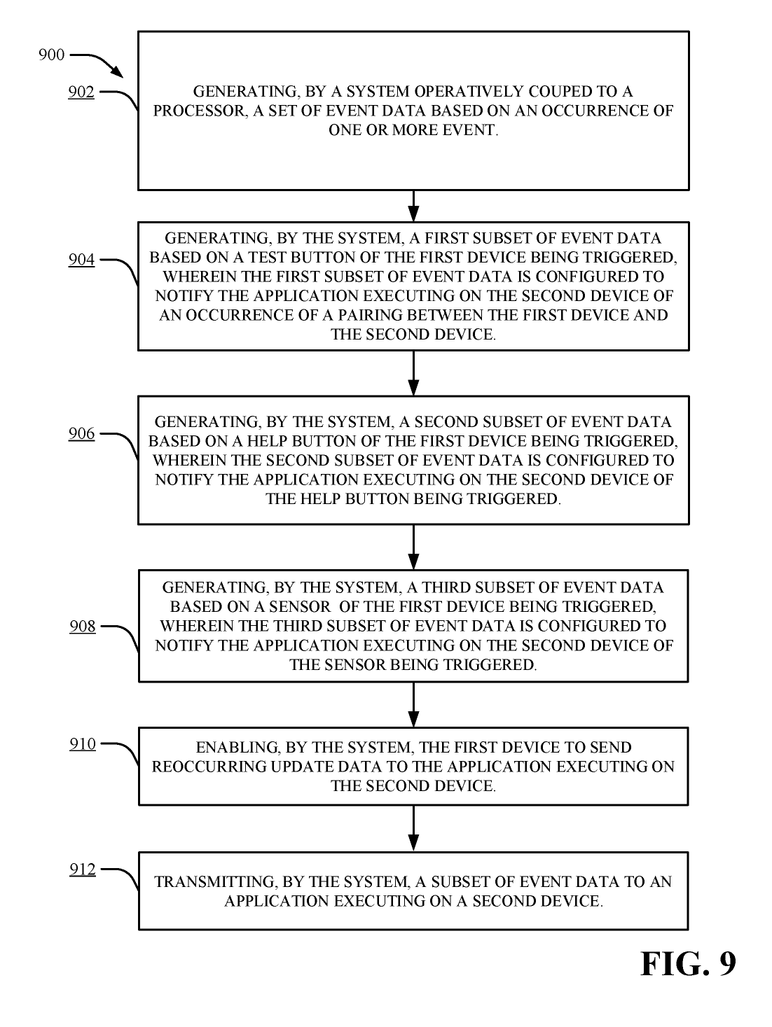

FIG. 9 illustrates a flow diagram of an example, non-limiting computer-implemented method that enables the first device to transmit reoccurring update data to an application executing on a second device in accordance with one or more embodiments described herein.

In an aspect, one or more of the components described in computer-implemented method 900 can be electrically and/or communicatively coupled to one or more devices. Repetitive description of like elements employed in other embodiments described herein is omitted for sake of brevity. In some implementations, at reference numeral 902, a system operatively coupled to a processor (e.g., processor 112) can generate (e.g., using generation component 110) a set of event data based on an occurrence of one or more event. At 904, the system can generate (e.g., using testing component 210) a first subset of event data based on a “I am ok” button of the first device being triggered, wherein the first subset of event data is configured to notify the application executing on the second device of an occurrence of a pairing between the first device and the second device.

At reference numeral 906, the system can generate (e.g., using assistance component 220) a second subset of event data based on a help button of the first device being triggered, wherein the second subset of event data is configured to notify the application executing on the second device of an occurrence of a pairing between the first device and the second device. At reference numeral 908, the system can generate (e.g., using sensing component 230) a third subset of event data based on a sensor of the first device being triggered, wherein the second subset of event data is configured to notify the application executing on the second device of the sensor being triggered. At reference numeral 910, the system can enable (e.g., using communication component 120) the first device to transmit reoccurring update data to the application executing on the second device. At reference numeral 912, the system can transmit (e.g., using communication component 120) a subset of event data to an application executing on a second device.

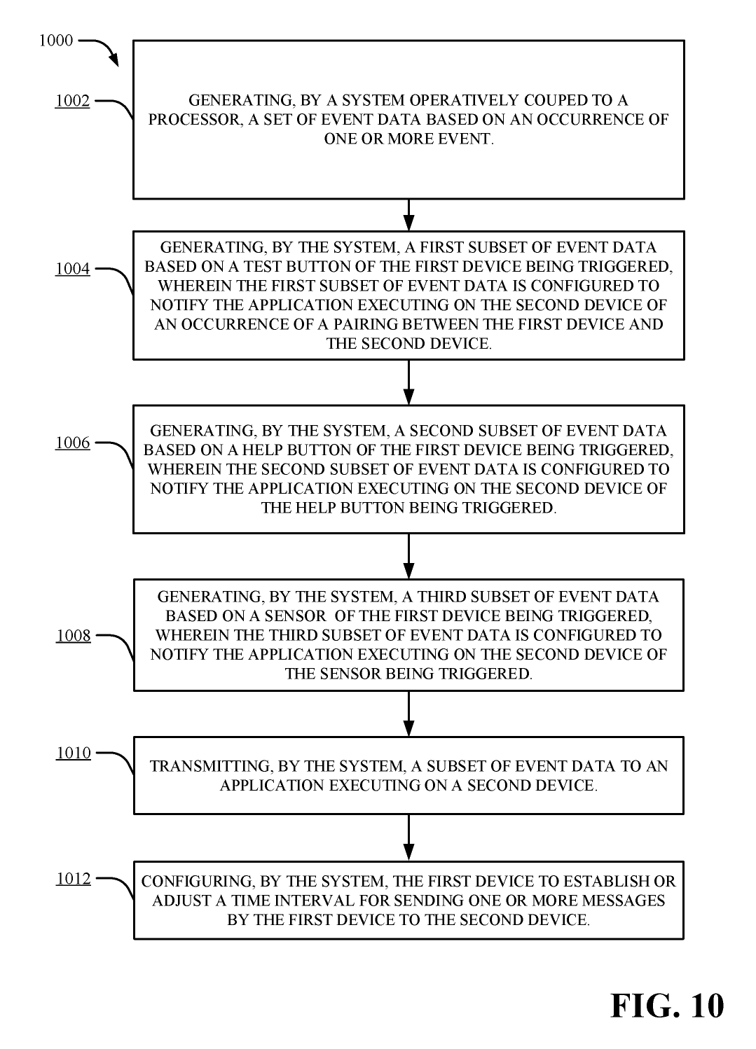

FIG. 10 illustrates a flow diagram of an example, non-limiting computer-implemented method that facilitates a configuration of the first device from an application executing on a second device in accordance with one or more embodiments described herein.

In an aspect, one or more of the components described in computer-implemented method 1000 can be electrically and/or communicatively coupled to one or more devices. Repetitive description of like elements employed in other embodiments described herein is omitted for sake of brevity. In some implementations, at reference numeral 1002, a system operatively coupled to a processor (e.g., processor 112) can generate (e.g., using generation component 110) a set of event data based on an occurrence of one or more event. At 1004, the system can generate (e.g., using testing component 210) a first subset of event data based on a “I am ok” button of the first device being triggered, wherein the first subset of event data is configured to notify the application executing on the second device of an occurrence of a pairing between the first device and the second device.

At reference numeral 1006, the system can generate (e.g., using assistance component 220) a second subset of event data based on a help button of the first device being triggered, wherein the second subset of event data is configured to notify the application executing on the second device of an occurrence of a pairing between the first device and the second device. At reference numeral 1008, the system can generate (e.g., using sensing component 230) a third subset of event data based on a sensor of the first device being triggered, wherein the second subset of event data is configured to notify the application executing on the second device of the sensor being triggered. At reference numeral 1010, the system can transmit (e.g., using communication component 120) a subset of event data to an application executing on a second device. At reference numeral 1012, the system can configure the first device to establish or adjust a time interval for transmitting one or more message by the first device to the second device.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because a generation of data is performed utilizing iterative machine learning and artificial intelligence techniques that facilitate a recurrent and precise generation of equipment failure data based on an occurrence of activities and/or events related to a device and such conversion of physical activity to digital data are performed by components executed by a processor (e.g., processor 112) established from a combination of electrical and mechanical components and circuitry, a human is unable to replicate or perform the subject data packet configuration and/or the subject communication between processing components, a generation component and/or a communication component. Furthermore, the configuration of a device and parameters that generate modified data sets from raw data sets are based on determinations that only a computer can perform such as iterative updating of reoccurring device event data and activities, evaluation, and review of event data based on unique signatures within the data and use of computer-implemented operations to recognize digital patterns within computer generated data representations to iteratively generate, transmit, and characterize data associated with a device event. The generation of digital data based on pattern recognition algorithms and data similarity algorithms as well as storage and retrieval of digitally generated data to and from a memory (e.g., using memory 108) in accordance with computer generated access patterns cannot be replicated by a human.

Also, the systems and methods disclosed herein can be integrated with the tangible and physical infrastructure components of one or more oil and gas exploration equipment at one or more localities. In another aspect the systems and methods disclosed can be integrated with physical devices such as key fob device (e.g., first device), tablets, desktop computers, mobile devices, and other such hardware. Furthermore, the ability to employ iterative machine learning techniques to categorize event data associated with several key fob device technologies simultaneously cannot be performed by a human. For example, a human is unable to match the identities and transmit messages to corresponding identities of thousands of devices simultaneously nevertheless based on matching algorithms, machine learning techniques and artificial intelligence comparative techniques in an efficient and accurate manner. Furthermore, a human is unable to simultaneously access and transmit generated device data associated with a device activity, device historical trend data, artificial intelligence generated device performance data and/or packetized data for communication between a main processor (e.g., using processor 112) and a memory (e.g., memory 108) to simultaneously facilitate the generation and transmission of event based data of a device. In another aspect, data stored in memory 108, memory 106, and/or memory 104 can comprise data characteristics that eliminate wasteful information and include information that is most indicative of an emergency event occurring in association with the user and/or possessor of device 102. For instance, in an aspect, generation component 110 can generate data in accordance with an occurrence of a triggering event based on the triggering event satisfying various criteria. For instance, the triggering event can that causes a jarring movement to device 102 versus a mild tremor may be better indicia of an emergent situation occurring in relation to the owner and/or possessor of device 102. Accordingly, the former triggering event can cause the generation of data indicating a need for assistance rather than the latter triggering event.

In another aspect, device 102 can utilize machine learning models in connection with generation component 110 to facilitate comparisons and recognition of patterns in data associated with events and the use of device 102. For instance, over time a user may utilize device 102 in a similar manner and such use-case scenarios can be reflected in generated data patterns associated with device 102. Accordingly, when such data patterns are generated in subsequent use-cases, device 102 can better understand whether an emergent triggering event has occurred or a typical use-case scenario has occurred. Furthermore, in an aspect, based on such machine learned identification of data patterns associated with typical and atypical use of device 102, device 102 can utilize generation component 110 and communication component 120 to better identify, generate, and transmit data in accordance with emergent events to assist a user in a time of need.

In another aspect, the data stored at memory 108, 106, and 104 are structured to allow for efficient and expedient retrieval and access of such data. Furthermore, such data is void of unessential data to allow for storage of such data using limited space in memory 108, 106, and 104. In another aspect, the problems associated with battery life on a smart device (e.g., device 302) did not exist prior to the proliferation of mobile application technologies. However, since such time, solutions to saving battery life and power associated with a mobile device have been important. Accordingly, the systems, methods, and devices disclosed herein facilitate a solution to this recent problem in that it allows some of the safety activities and communication activities associated with device 102 to operate using a mobile device while such mobile device is in power saving mode thereby using very little power from the mobile device. In another aspect, the systems, methods and computer products disclosed herein can be utilized in various mechanical devices including device 102, device 302, device 402 as well as other mechanical technologies utilized by employees and consumers in various employment settings.

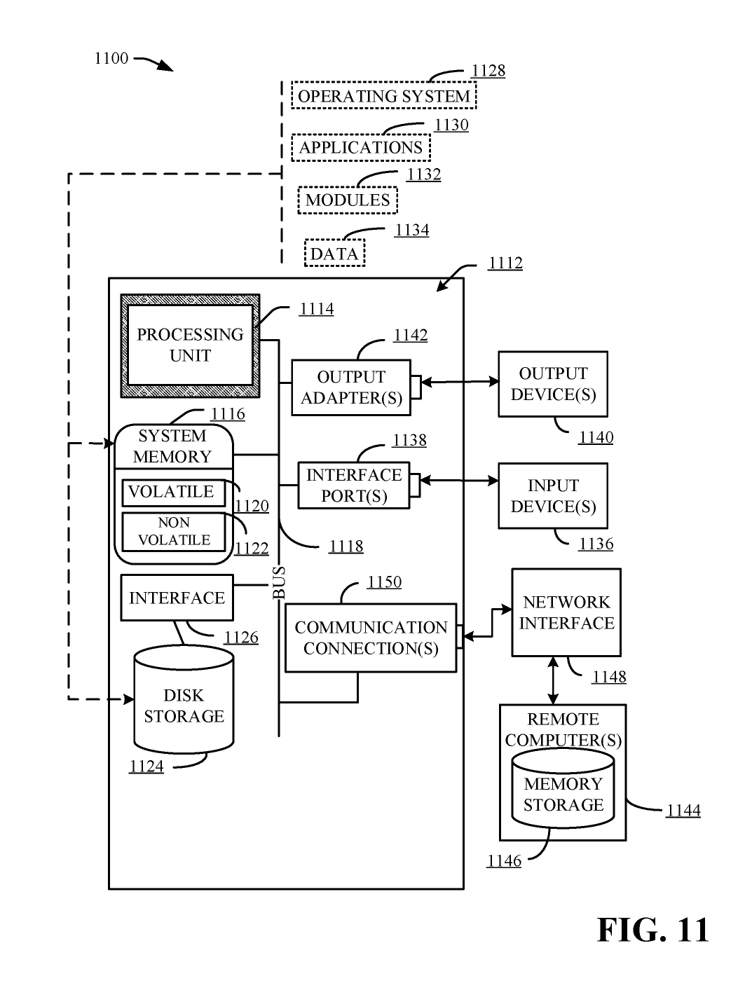

In order to provide a context for the various aspects of the disclosed subject matter, FIG. 11 as well as the following discussion is intended to provide a general description of a suitable environment in which the various aspects of the disclosed subject matter can be implemented. FIG. 11 illustrates a block diagram of an example, non-limiting operating environment in which one or more embodiments described herein can be facilitated. With reference to FIG. 11, a suitable operating environment 1100 for implementing various aspects of this disclosure can also include a computer 1112. The computer 1112 can also include a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114. The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1116 can also include volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 can also include removable/non-removable, volatile/non-volatile computer storage media. FIG. 11 illustrates, for example, a disk storage 1124. Disk storage 1124 can also include, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used, such as interface 1126. FIG. 11 also depicts software that acts as an intermediary between users and the basic computer resources described in the suitable operating environment 1100. Such software can also include, for example, an operating system 1128. Operating system 1128, which can be stored on disk storage 1124, acts to control and allocate resources of the computer 1112.

System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems. A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapter 1242 is provided to illustrate that there are some output device 1140 like monitors, speakers, and printers, among other such output device 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a computer, a server, a router, a network PC, a workstation, a microprocessor based appliance, a peer device or other common network node and the like, and typically can also include many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1150 refers to the hardware/software employed to connect the network interface 1148 to the system bus 1118. While communication connection 1150 is shown for illustrative clarity inside computer 1112, it can also be external to computer 1112. The hardware/software for connection to the network interface 1148 can also include, for exemplary purposes only, internal and external technologies such as, modems including regular telephone grade modems, cable modems and DSL modems, ISDN adapters, and Ethernet cards.

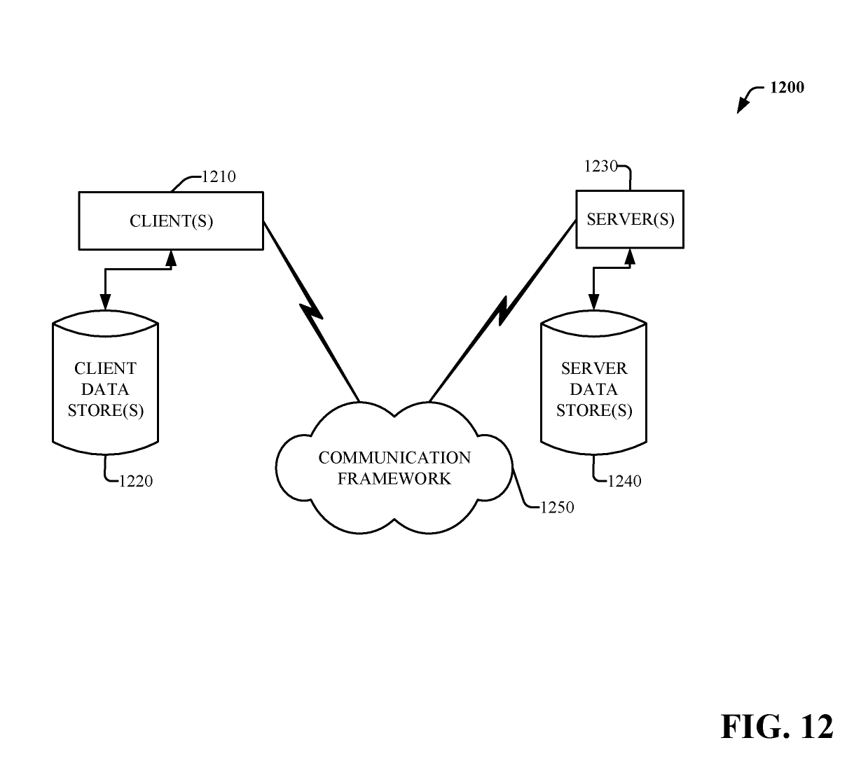

Referring now to FIG. 12, there is illustrated a schematic block diagram of a computing environment 1200 in accordance with this disclosure. The system 1200 includes one or more client(s) 1202 (e.g., laptops, smart phones, PDAs, media players, computers, portable electronic devices, tablets, and the like). The client(s) 1202 can be hardware and/or software (e.g., threads, processes, computing devices). The system 1200 also includes one or more server(s) 1204. The server(s) 1204 can also be hardware or hardware in combination with software (e.g., threads, processes, computing devices). The servers 1204 can house threads to perform transformations by employing aspects of this disclosure, for example. One possible communication between a client 1202 and a server 1204 can be in the form of a data packet transmitted between two or more computer processes wherein the data packet may include video data. The data packet can include a metadata, e.g., associated contextual information, for example. The system 1200 includes a communication framework 1206 (e.g., a global communication network such as the Internet, or mobile network(s)) that can be employed to facilitate communications between the client(s) 1202 and the server(s) 1204.

Communications can be facilitated via a wired (including optical fiber) and/or wireless technology. The client(s) 1202 include or are operatively connected to one or more client data store(s) 1208 that can be employed to store information local to the client(s) 1202 (e.g., associated contextual information). Similarly, the server(s) 1204 are operatively include or are operatively connected to one or more server data store(s) 1210 that can be employed to store information local to the servers 1204. In one embodiment, a client 1202 can transfer an encoded file, in accordance with the disclosed subject matter, to server 1204. Server 1204 can store the file, decode the file, or transmit the file to another client 1202. It is to be appreciated, that a client 1202 can also transfer uncompressed file to a server 1204 and server 1204 can compress the file in accordance with the disclosed subject matter. Likewise, server 1204 can encode video information and transmit the information via communication framework 1206 to one or more clients 1202.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a generation component that generates, by a first device, a set of event data based on an occurrence of one or more event; and
a communication component that transmits, by the user device, a subset of event data to a first application executing on a second device.

2. The system of claim 1, further comprising a testing component that generates a first subset of event data based on a test button of the first device being triggered, wherein the first subset of event data is configured to notify the application executing on the second device of an occurrence of a pairing between the first device and the second device.

3. The system of claim 1, further comprising an assistance component that generates a second subset of event data based on a help button of the first device being triggered, wherein the second subset of event data is configured to notify the application executing on the second device of the help button being triggered.

4. The system of claim 1, further comprising a sensing component that generates a third subset of event data based on a sensor of the first device being triggered, wherein the third subset of event data is configured to notify the application executing on the second device of the sensor being triggered.

5. The system of claim 2, wherein the communication component transmits the first subset of event data, a second subset of event data, or a third subset of event data to the application executing on the second device.

6. The system of claim 1, wherein the first application executing on the second device comprises a tracking component that enables the first device to transmit reoccurring update data to the application executing on the second device.

7. The system of claim 6, wherein the first application executing on the second device comprises a first configuration component that configures the first device to establish or adjust a time interval for sending one or more messages by the first device to the second device.

8. The system of claim 7, wherein the first application executing on the second device comprises a second configuration component that configures the first device to establish or adjust an amount of messages to send by the first device to the second device within the time interval.

9. The system of claim 8, wherein the communication component further transmits the amount of messages at an established frequency or an adjusted frequency within the time interval based on one or more configurations by the first configuration component or the second configuration component.

10. The system of claim 7, wherein the first application executing on the second device comprises a third configuration component that configures the first device to establish or adjust a check-in requirement on the first device, wherein a triggering data must be deployed by the first device in response to a check-in message generated by the application executed on the second device.

11. The system of claim 1, wherein the first application executing on the second device or a second application executing on a third device, comprises a matching component that matches a first identifier associated with the first device to a set of identifiers associated with a set of authorized user devices, wherein the set of identifiers represent authorized user devices contact information for receiving the subset of event data.

12. A computer-implemented method, comprising:
generating, by a system operatively coupled to a processor, a set of event data based on an occurrence of one or more event; and
transmitting, by the system, a subset of event data to an application executing on a second device.

13. The computer-implemented method of claim 12, further comprising generating, by the system, a first subset of event data based on a test button of the first device being triggered, wherein the first subset of event data is configured to notify the application executing on the second device of an occurrence of a pairing between the first device and the second device.

14. The computer-implemented method of claim 12, further comprising generating, by the system, a second subset of event data based on a help button of the first device being triggered, wherein the second subset of event data is configured to notify the application executing on the second device of the help button being triggered.

15. The computer-implemented method of claim 12, further comprising generating, by the system, a third subset of event data based on a sensor of the first device being triggered, wherein the third subset of event data is configured to notify the application executing on the second device of the sensor being triggered.

16. The computer-implemented method of claim 13, further comprising transmitting, by the system, the first subset of event data, a second subset of event data, or a third subset of event data to the application executing on the second device.

17. The computer-implemented method of claim 12, further comprising enabling, by the system, the first device to send reoccurring update data to the application executing on the second device.

18. The computer-implemented method of claim 12, further comprising configuring, by the system, the first device to establish or adjust a time interval for sending one or more messages by the first device to the second device.

19. A computer program product for facilitating a communication between two or more devices based on an occurrence of an event, the computer program product comprising a computer readable storage medium having program instructions embodied therewith, the program instructions executable by a processor to cause the processor to:
generate a set of event data based on an occurrence of one or more event; and
transmit a subset of event data to an application executing on a second device.

20. The computer program product of claim 19, wherein the program instructions are further executable by the processor to cause the processor to:
generates a first subset of event data based on a test button of the first device being triggered, wherein the first subset of event data is configured to notify the application executing on the second device of an occurrence of a pairing between the first device and the second device.
